(19) United States
(12) Patent Application Publication
(10) Pub. No.: US 2025/0356201 A1
(43) Pub. Date: Nov. 20, 2025

(54) TIME SERIES MODEL TRAINING USING A LARGE LANGUAGE MODEL

(71) Applicant: Royal Bank of Canada, Toronto (CA)

(72) Inventors: Hossein Sharifi Noghabi, Vancouver (CA); Tristan Jean Claude Sylvain, Montreal (CA); Gabriel L. Oliveira, Vancouver (CA); Can Chen, Montreal (CA)

(21) Appl. No.: 19/206,436

(22) Filed: May 13, 2025

(30) Foreign Application Priority Data
May 14, 2024 (US) 63/647219

(51) Int. Cl. G06N 3/0895

(52) U.S. Cl. CPC G06N 3/0895

(57) ABSTRACT

A time series prediction model can be trained using a Large Language Model. A corresponding text representation of the time series can be generated and applied to the LLM in order to generate a hidden representation of the text description. The time series may be applied to the time series prediction model to generate a hidden representation of the time series. The time series prediction model can be trained to maximize mutual information between the two hidden representations. The mutual information between the two hidden representations may be determined based on a discriminator, which may also be trained based on maximizing the mutual information.

### RELATED APPLICATION

The current application claims priority to U.S. Provisional Application No. 63/647,219 filed May 14, 2024 and titled “Time Series Model Training Using A Large Language Model” the entire contents of which are incorporated herein by reference in their entirety for all purposes.

### TECHNICAL FIELD

The current disclosure relates to time series analysis and in particular to training of time series models using a large language model.

### BACKGROUND

Time series analysis is important in a wide range of applications including for example in weather prediction and anomaly detection. Traditional time series analysis methods often struggle with data scarcity due to high data labeling costs. Recent attempts have turned to Large Language Models (LLMs) for their exceptional ability in time series information extraction. However, these methods rely on the LLMs as the central predictive backbone, which tends to overlook the essential mathematical attributes of traditional time series models. The LLMs neglect traditional time series models' critical mathematical attributes, such as periodicity. Further, the LLM are trained on natural languages and it is non-trivial to align the time series embedding with the language embedding space to enable fine-grained predictions.

An additional, alternative and/or improved method for time series analysis is desirable.

### BRIEF DESCRIPTION OF THE DRAWINGS

Further features and advantages of the present disclosure will become apparent from the following detailed description, taken in combination with the appended drawings, in which:

FIG. 1 depicts a system implementing a time series model;

FIG. 2 depicts the training of the time series model;

FIG. 3 depicts training process of a time series model;

FIG. 4 a method of training a time series model;

FIG. 5 depicts a process for generating a text representation of a time series;

FIG. 6 depicts further training process of a time series model;

FIG. 7 depicts a further method of training a time series model;

FIG. 8 depicts details of refining model parameters;

FIG. 9 depicts the training and application of different time series models; and

FIG. 10 depicts a radar graph of results of different models on different tasks.

### DETAILED DESCRIPTION

In accordance with the present disclosure there is provided a method of training a time series model comprising: receiving training data comprising a time-series and associated ground truth results; inputting a portion of the training data, x, to a time series model to provide a time series hidden representation,

$${h}_{θ}^{m} ( x ) ,$$

of the input portion of the training data from the time series model, the time series model being trained to predict the ground truth results; inputting text description, t, corresponding to the training data x to a large language model (LLM) to provide an LLM hidden representation, h^{l}(t), of the input text description corresponding to the portion of the training data from the LLM, the LLM trained to output a text response from an input; determining mutual information between

$${h}_{θ}^{m} ( x )$$

and h^{l}(t) using a discriminator model T_{β}; and adjusting parameters, 0θ, of the time series model based at least in part on the determined mutual information between

$${h}_{θ}^{m} ( x )$$

and h^{l}(t).

In a further embodiment of the method, adjusting parameters, θ, is calculated based on an overall loss function comprising: a predictive loss based on the training data x and a corresponding ground truth label y; and a mutual information maximization loss based on the mutual information between

$${h}_{θ}^{m} ( x )$$

and h^{l}(t).

In a further embodiment of the method, the overall loss function [symbol] (θ) is defined by:

$$ℒ ( θ , β ) = \frac{1}{N} {\sum }_{i}^{N} {l}_{O}^{i} + I ( θ , β )$$

where N is a number of samples in the training data x;

$${l}_{O}^{i}$$

is the predictive loss for sample i; I(θ, β) is the mutual information maximization loss; θ is the parameters of the time series model; and β is the parameters of the discriminator model.

In a further embodiment of the method, the overall loss function assigns different sample weightings to the predictive loss function and the loss function maximizing the mutual information.

In a further embodiment of the method, the overall loss function [symbol] (θ, α) is defined by: [symbol] (θ, α)=mean (ωₒ(α)·lₒ)+mean (ω_{I}(α)·[−I(θ, β, ω_{I}(α)] where: lₒ is a predictive loss function; −I(θ, β, ω_{I}(α) is a mutual information maximization loss function; ωₒ(α) is a predictive loss weighting; and ω_{I}(α) is a mutual information maximization loss weighting; α is the parameters of a weighting network MLP_{α}; and ωₒ(α), ω_{I}(α)=MLP_{α}(lₒ).

In a further embodiment of the method, the weighting network is trained as a bi-level optimization problem.

In a further embodiment of the method, the method further comprises: training the discriminator model T_{β}using the received training data.

In a further embodiment of the method, parameters β of T_{β}are optimized according to:

$$\hat{β} = β - {η}_{0} \cdot \frac{\partial I ( θ , β )}{\partial β} , with : I ( θ , β ) = {𝔼}_{𝕤} [ - sp ( - {T}_{β} ( {h}_{θ}^{m} ( x ) , {h}^{l} ( t ) ) - {𝔼}_{𝕤 \times \tilde{𝕤}} [ sp ( - {T}_{β} ( {h}_{θ}^{m} ( x ) , {h}^{l} ( \tilde{t} ) ) ,$$

where: ηₒ is a learning rate; [symbol] [] is an expected value; and sp is a softplus function.

In a further embodiment of the method, the method further comprises converting the input portion of training data to a text description, t, corresponding to the input portion of training data.

In a further embodiment of the method, the method is repeated for a plurality of training epochs before deploying the time series model with the adjusted parameters.

In a further embodiment of the method, the method further comprises: generating the text description t based on a template.

In accordance with the present disclosure there is further provided a non-transitory computer readable medium having instructions stored thereon, which when executed by a processor configure a system to perform a method according to any of the methods described above.

In accordance with the present disclosure there is further provided a system comprising: a processor for executing instructions; and a non-transitory computer readable medium having instructions stored thereon, which when executed by the processor configure the system to perform a method according to any of the methods described above.

As described further below, a time series model can be trained using a large language model (LLM). The training described below effectively integrates the LLMs' insights with the mathematical attributes of traditional time series models. The training enhances a traditional time series with LLM-derived intelligence for improved prediction. Further, the LLM-enhanced training of the time series model can improve the training even with sparse training data. The LLM insights are incorporated into the time series model's training by maximizing the mutual information between traditional model's time series representations and LLM-generated textual representation counterparts. While the training of the time series model incorporating the LLM may be more computationally expensive compared to training a time series model without an LLM, once trained, the two time series models require the same or similar computational resources. Although a time series model trained with an LLM and a time series model trained without an LLM may use similar computational resources, the results of the time series model trained with the LLM may be better compared to those of the non-LLM trained time series model.

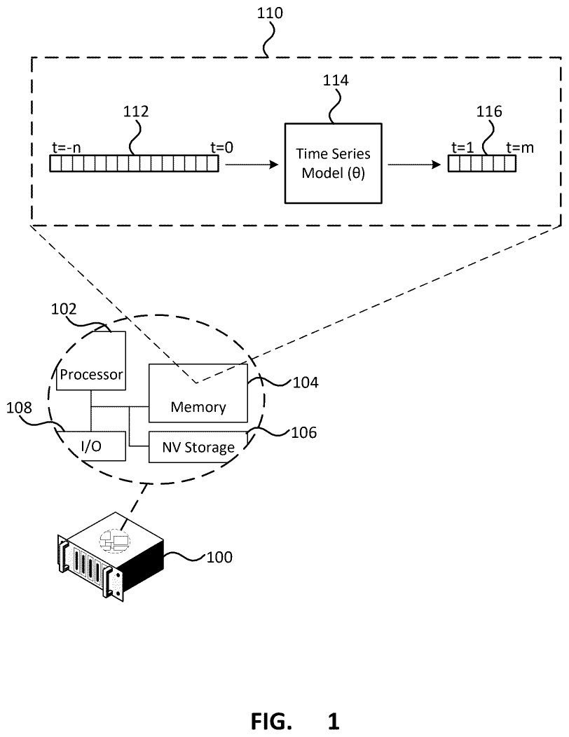

FIG. 1 depicts a system implementing a time series model. The system is depicted as a single server 100; however, the system may be implemented by one or more computing devices, including for example multiple servers or computing devices communicatively coupled together by one or more networks. The system may be implemented on cloud computing devices that allow compute resources to be effectively scaled as required. Regardless of the particular implementations, the system includes at least one processor 102 that is capable of executing instructions stored in memory 104. The memory 104 may comprise at least one memory unit storing the instructions or portions of the instructions as well as the data, or portions of the data. In addition to the memory 104 which may be volatile, the system may include non-volatile storage 106 for storing instructions and/or data. The system 100 may further include one or more input/output (I/O) interfaces for coupling one or more input and/or output devices to the system, including for example Graphical Processing Units (GPUs) or other dedicated or specialized processing devices. The at least one processor 102 executes instructions in order to configure the system to provide various functionality, including time series analysis functionality 110.

The time series analysis functionality 110 may receive a time series dataset, or a portion of a time series dataset 112, depicted as comprising a time series of historical data from t=−n to t=0, that is data from some time in the past to the present. The time series data 112 can be input to a trained time series model, trained to optimize some set of parameters θ in order to predict an output. As depicted, the output may comprise predicted future values 116 of the time series from t=1 to t=m. The trained time series model 114 is depicted as forecasting some future values of data based on historical values of data. While forecasting is an important application of time series analysis, the time series model may be trained for other applications, including for example anomaly detection, data imputation, and activity recognition. Regardless of the particular application, the time series model can be trained to predict an output, such as the forecasted future values, missing values from the data, a detected anomaly, a particular activity being performed, etc.

The approach described herein uses a traditional time series model, that is a time series model that can account for or consider the mathematical properties of the time series, as the core predictive model, with the training of the time series model enhanced with insights derived from LLMs to improve its predictive capabilities and facilitate the training. This enhancement process is achieved by maximizing the mutual information between the traditional model's time series representations and textual representations derived from the pre-trained LLM. Considering the usual lack of textual data for time series analysis, a method of generating such text descriptions is also described. To enrich the LLM's comprehension of time series, this text generation approach can incorporate both background and statistical information about the data in natural language.

The training approach combines two learning objectives. One is the standard prediction loss of the time series model and the other corresponds to maximizing the mutual information between the time series representation and the text representation.

The time series model is described further below as being the TimesNet predictive model, although other time series models can be used, including for example recurrent neural network (RNN) based models, convolutional neural networks (CNN) based models, including for example CNN along the temporal dimension (TCN), transformer based models including for example transformers with attention mechanisms. The time series models may include existing models such as ETSformer, Stationary, or FreTS. The time series model may be suited for use with time series that are univariate or multivariate and are stationary or non-stationary. That is, the training process described herein provides flexibility on the time series model being trained, allowing an appropriate model to be selected based on the data and/or application.

The TimesNet model, described by Wu et al. in “TimesNet: Temporal 2D-Variation Modeling For General Time Series Analysis,” of The Eleventh International Conference on Learning Representations, 2023 the entire contents of which are incorporated herein by reference for all purposes, may be well suited for modeling temporal variations in time series. TimesNet decomposes these complex variations of the time series into multiple intra-period and inter-period variations. This is achieved by transforming the 1D time series into a series of 2D tensors, each corresponding to different periods. By employing this method, TimesNet adeptly identifies and encapsulates the nuanced variations within and between periods. The TimesNet model may be parameterized by θ. For a time series, x, a hidden representation h_{θ}^{m}(x) can be obtained from the TimesNet model. It will be appreciated that other models with different parameters can be trained using the technique described herein.

When training the time series predictive model, such as TimesNet, a trained large language model (LLM) is used to enhance the training. LLMs undergo training on vast collections of natural language sequences, with each sequence comprising multiple tokens. Prominent large language models such as GPT-3 and Llama2, and BERT aim to predict the subsequent token based on its preceding tokens, showcasing their prowess through enhancements in both the model's parameter size and the volume of training data. Each LLM is equipped with a tokenizer that deconstructs an input string into a sequence of discernible tokens. However, the training regime for current LLMs focuses exclusively on natural language, omitting time series data. This specificity poses challenges in the straightforward application of large language models to time series analysis. As described below, the LLM is incorporated into the training of the traditional time series predictive model by maximizing mutual information between a representation of the time series from the time series model, and a representation of a text description corresponding to the time series from the LLM.

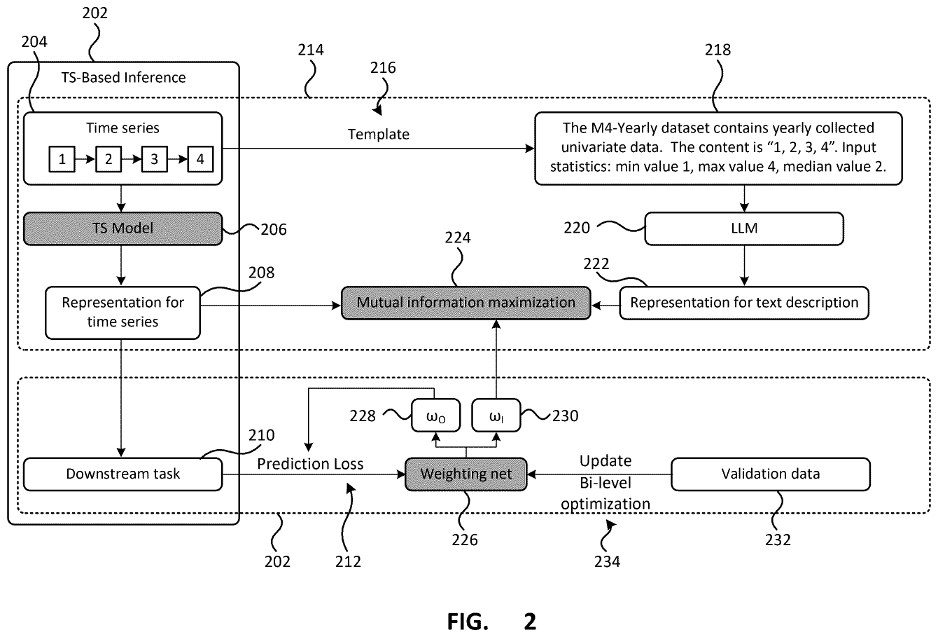

FIG. 2 depicts the training of the time series model. A time series (TS) based inference process 202 can receive a time series 204 of data, depicted as 4 ordered samples 1, 2, 3, 4. The time series, or a portion there of, can be applied to the TS Model 206 being trained. In FIG. 2 the grey boxes depict components that can be trained. The TS model can provide a representation of the time series 208 as well as a downstream task representation 210. Although depicted as separate representations, it is possible for the two representations to be the same. The Downstream task representation may depend upon the particular downstream task the TS model is being trained for. For example, if the TS model is being trained to predict future samples of the time series, the downstream representation by comprise a plurality of time series data samples. If the TS model is being trained to detect anomalies, the downstream task may be an indication of whether the TS data is associated with an anomaly or not. A prediction loss 212 can be computed based on the downstream task representation for the time series data and a ground truth, or label, associated with the time series data. The prediction loss 212 can be used in the training of the TS model. It is noted that training the TS model comprises calculating, possibly in one or more training epochs or cycles, values of parameters of the TS model.

In addition to the traditional prediction loss function, the TS model is further trained using the mutual information between the time series model and the LLM. The mutual information determination is depicted in box 214. In order to incorporate the LLM into the TS model training, a template 216 may be used to convert the time series data 204 into a corresponding text representation 218. The text description corresponding to the time series data can be input to the LLM 220 which generates a corresponding representation for the text description 222. The LLM may be a pre-trained LLM that was trained on large amount of text data. The LLM does not need further training or fine tuning in order to generate the representation for the text description. The mutual information between the time series representation and the LLM text representation can be determined from a discriminator model for mutual information maximization 224. The discriminator may be trained in order to maximize the mutual information.

The total loss function for training the TS model is based on the predictive loss function and the mutual information maximization loss function. The importance of each loss function for each sample may vary. Accordingly, the importance or weighting of each loss function can be adjusted by a weighting network 226. The weighting network can generate respective weightings 228, 230 for the predictive loss function and the mutual information maximization loss function. The weighting network may generate the weightings based on the prediction loss 212. Further, the weighting network can be trained as a bi-level optimization using validation data 232.

The training framework depicted in FIG. 2 includes a mutual information module. The core of this module is a traditional predictive model, which is enhanced with insights derived from LLMs to improve its predictive abilities. TimesNet was used as the traditional predictive model due to its exceptional performance and insight into periodic modeling. However, the training framework is also applicable to other traditional TS models. The LLM-enhancement is achieved by maximizing the mutual information between the TS representations from traditional models and their textual counterparts from LLMs, thereby bridging these two modalities. With textual descriptions often missing from TS data, generating such descriptions for example using a template allows the LLM to operate on the time series. This template can be enriched with essential background and statistical details pertinent to the TS, thereby enriching the LLM's comprehension of the TS context.

The TS model training uses a dual loss framework: traditional prediction and mutual information. The importance of samples can differ between the two losses. For instance, a large prediction loss for a sample highlights its learning potential, emphasizing the need to focus on its prediction loss. This scenario also implies that the model's learning for this sample is inadequate and its hidden representation is suboptimal for mutual information computation. Consequently, the sample's contribution to the mutual information calculation should be reduced. To manage this variability, a sample reweighting module can be used which may be powered by a MLP (multilayer perceptron) network. This sample reweighting module can process the sample prediction loss to produce dual weights for each sample, one for the prediction loss and another for the mutual information loss. These weights can be optimized through bi-level optimization, thereby enhancing the efficacy of information utilization.

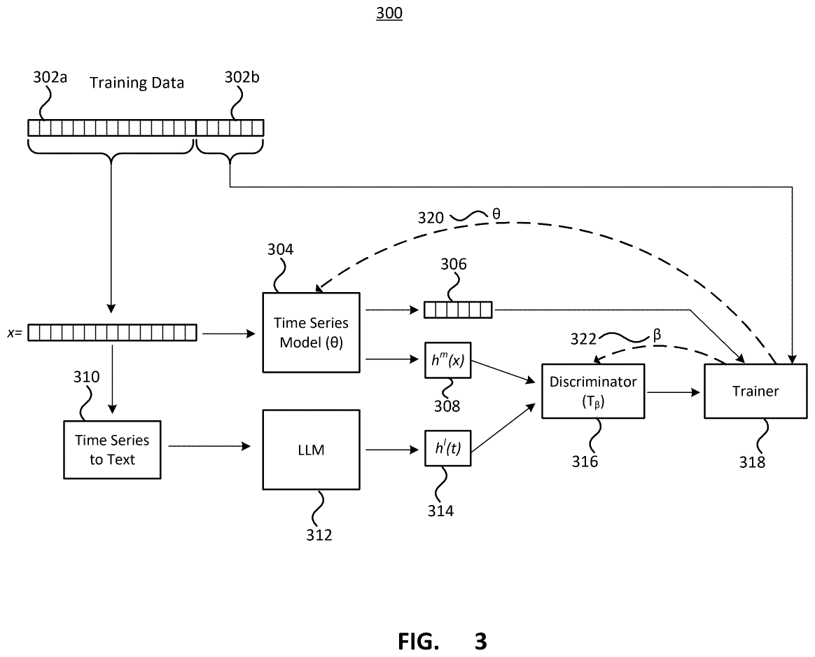

FIG. 3 depicts training process of a time series model. Although not depicted in FIG. 3, the training process 300 is implemented on one or more computing devices, such as the computing device 100 described above with respect to FIG. 1, although the time series model may be trained and deployed on different computing devices. Training data comprises some time series data 302a and the labelled results 302b or ground truth results. In FIG. 3 the training data may be for forecasting future data and as such the time series data 302a may comprise a subset of the data up to some point in time and the ground truth may comprise a subset of the data after the point in time. The ground truth or labelled results may take other forms depending upon the task or application being trained. For example, for data imputation, the time series data 302a may have some data removed or masked, which is then used as the labelled results or ground truth results 302b. Although the ground truth results is depicted as being a time series of data, the labelled results or ground truth may be a labelled activity, a detected anomaly, etc. The training data depicted in FIG. 3 may be a subset of a larger training dataset that is used for one round of training.

The training time series 302a is provided to a time series model 304, with parameters θ. The model 304 predicts an output 306 and also provides a hidden representation 308

$${h}_{θ}^{m} ( x )$$

of the input time series x. Although depicted as being different from each other, it is possible that the hidden representation and the output 306 are the same. In addition to providing the training time series 302a to the predictive model 304, the time series is converted to text by time series to text functionality 310. The time series to text functionality can generate the corresponding text using a template to convert the time series to a corresponding text string. Although a text string is depicted as being generated by time series to text functionality 310, it is possible that the corresponding text description is available from or may be generated from other sources. The text description, t, corresponding to the time series x is provided to a trained LLM 312 which provides a hidden representation 314 h^{l}(t) of the text. The mutual information between the two hidden representations

$${h}_{θ}^{m} ( x )$$

and h^{l}(t) is estimated by a discriminator T_{β}. Training functionality 318 may then train the time series model 304 with the two training objectives. The first training objective is the standard prediction loss of the time series model which may be based on minimizing a loss between the predicted output 306 and the labelled training output or ground truth result 302b. The second training objective is to maximize the mutual information estimated by the discriminator 316. The training can then update the time series model parameters 320 θ and another round of training performed. The training may continue for a number of cycles, or epochs, or until the loss does not change substantially. In addition to updating the time series model parameters 320, the trainer 318 may also update the parameters of the discriminator depicted as parameters 322 β.

Given a time series, x, and its associated text description, t, an estimate of the mutual information between the corresponding representations is needed. For the time series x the representation

$${h}_{θ}^{m} ( x )$$

is derived from the time series model, such as TimesNet, parameterized by θ. For the associated text description t, the pre-trained LLM is used to derive a representation h^{l}(t). The mutual information between the two representations can be estimated, for example via the Jensen-Shannon MI estimator described by Sun et al. in “InfoGraph: Unsupervised and Semi-supervised Graph-Level Representation Learning via Mutual Information Maximization” of International Conference on Learning Representations, 2020, the entire contents of which are incorporated herein by reference for all purposes. Other methods of estimating the mutual information may be used such as the MINE estimator. Specifically, let (x, t) represent a sample from a time series x and its corresponding text description t, from the time series set [symbol] , and (\tilde{x}, \tilde{t}) denote a sample from [symbol] = [symbol] , where (x, t)≠(\tilde{x}, \tilde{t}). Within this context, [symbol] denotes the time series training distribution while the product [symbol] × [symbol] represents pairs of distinct samples within S. The lower bound of mutual information can be estimated by:

$$I ( θ , β ) = {𝔼}_{𝕤} [ - sp ( - {T}_{β} ( {h}_{θ}^{m} ( x ) , {h}^{l} ( t ) ) ] - {𝔼}_{𝕤 \times \tilde{𝕤}} [ sp ( - {T}_{β} ( {h}_{θ}^{m} ( x ) , {h}^{l} ( \tilde{t} ) ) ] \qquad ( 1 )$$

In equation (1), [symbol] represents the expected value, T_{β}denotes the discriminator parameterized by β, and sp is the softplus function. The discriminator 316 may be provided by feeding positive and negative examples of mutual information into a 1-layered fully connected network parameterized by β and then output the dot product of the two representations. The discriminator may be trained by optimizing β according to:

$$\hat{β} = β - {η}_{0} \cdot \frac{\partial I ( θ , β )}{\partial β} \qquad ( 2 )$$

When initially training the discriminator using equation (2), the parameters θ of the time series model may be fixed, which may be determined initially by minimizing a prediction loss lₒ. In equation (2), ηₒ denotes a learning rate. Once the time series model and the discriminator are initially trained, the parameters may be refined or optimized further using the training data. The time series model parameters may be optimized on both the minimization of the prediction loss and the maximization of the mutual information, or only on the minimization of the prediction loss. The time series model parameters and the discriminator model parameters may be adjusted in each training epoch, or only a single model may be trained in a particular training epoch. The discriminator parameters may be further refined based on the mutual information maximization. The loss function for training the time series model may depend on the particular time series model. For revising the discriminator parameters based on the mutual information equation (2) can be used. Similarly, the time series model parameters can be updated based on minimizing the prediction loss according to:

$$\hat{θ} = θ - {η}_{0} \cdot \frac{\partial {l}_{O}}{\partial θ} \qquad ( 3 )$$

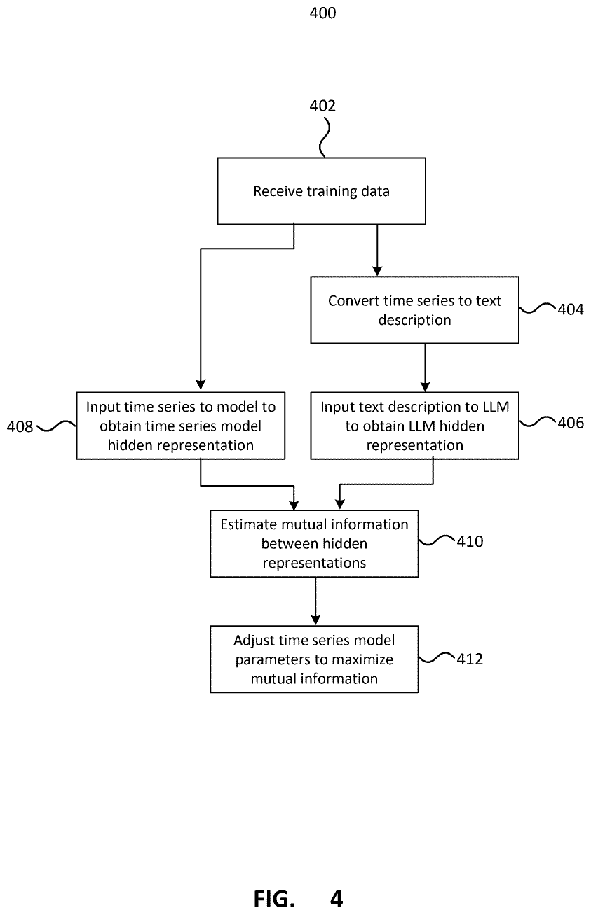

FIG. 4 a method of training a time series model. The method 400 receives training data (402), which may comprise time series data. The time series, which may be a subset or portion of the received training data, is converted to a text description corresponding to the time series (404). The text description is input to a trained LLM to obtain a hidden LLM representation of the text description (406). The time series, which was converted to the text description, is input into an initially trained times series model in order to obtain a time series hidden model hidden representation of the time series (408). The mutual information between the two hidden representations is estimated (410) and used to adjust the time series model parameters in order to maximize the mutual information (412). Although not depicted in FIG. 4, the parameters of an initially trained discriminator used to estimate the mutual information may also be adjusted to maximize the mutual information.

A training algorithm for training the time series model using LLM enhancements, referred to as LLM-Time, is described below.

Algorithm 1 LLM-Time-Integrator

Input: The time series dataset [symbol] , the number of training iterations T
Output: The trained model parameterized by θ*

| | |
|---|---|
| 1: | Train a TimesNet model parameterized by θ on [symbol] . |
| 2: | Generate the text description t for the time series x |
| 3: | Derive hidden representations h_{θ}^{m}(x) from TimesNet |
| 4: | Derive hidden representation h^{l}(t) from the LLM |
| 5: | Train a discriminator model to T_{β} to estimate mutual information |
| 6: | for τ ← 0 to T − 1 do |
| | 1: Sample x_{batch}, t_{batch}, y_{batch} from the training data |
| | 2: Compute the mutual information loss |
| | 3: Compute the overall loss |
| | 4: Update model parameters based on overall loss |
| | 5: Refine the discriminator model T_{β} |
| 7: | Return the trained model parameterized by θ*. |

In the above, x_{batch}, t_{hatch}, y_{batch} are from the time series, corresponding text description, and labelled output or ground truth respectively. The overall loss [symbol] (θ, β) can be computed based on the prediction loss as described above in equation (3) or a combination of the predictive loss and the mutual information according to:

$$ℒ ( θ , β ) = \frac{1}{N} {\sum }_{i}^{N} {l}_{O}^{i} + I ( θ , β ) \qquad ( 4 )$$

The training process relies upon a text description of a time series, which may not be available. In such cases, the text description can be automatically generated, for example by converting the time series representation into a text according to a predefined template.

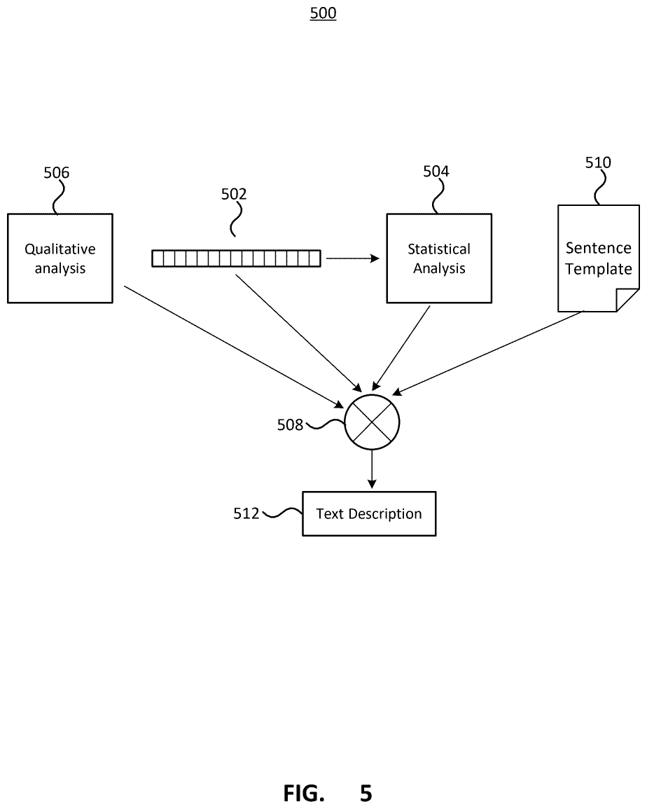

FIG. 5 depicts a process for generating a text representation of a time series. The text generation process depicted in FIG. 5 generates a text description from an input time series 602. Statistical analysis 604 is performed on the time series in order to determine statistical information such as one or more of the mean value, average value, median value, max value, min value, etc. Qualitative analysis 606 may performed to determine qualitative descriptions of the data set. The qualitative analysis may simply use a user's input of the description of the data set, or may analyze the data to determine a description, such as “Weather data from 1995 to 2015.” The qualitative analysis and the statistical analysis can then be combined together 608 according to a sentence template 610. Various sentence templates may be provided. The sentence template describes how to incorporate the time series, qualitative analysis and statistical analysis into the text description 612. For example, a text template may specify that the text description comprises the task description, which may be provided from the qualitative analysis, followed by “the content of the time series is: ” with the text of the time series. The statistical analysis may be included as sentences such as “The min value is: ” followed by the min value determined from the statistical analysis. It will be appreciated that various different sentence templates can be provided to generate a corresponding text description of the time series. An example template for generate the corresponding text input for a time series TS is provided below.

```
Template = (
  “{task_description}. The content is: {TS}. ”
  “Input statistics: min value {min (TS) }, max value {max (TS) }, ”
  “median value {median (TS) }, top 5 lags {compute_lags (TS) } .”
```

In the above {task_description} is a text description of the task or time series. {TS} is the time series in text form. {min(TS)} is the minimum value of the time series, {max(TS)} is the maximum value of the time series, {median(TS)} is the median value of the time series and {compute_lags(TS)} is the top 5 lags in the time series.

As described above, the time series model may be trained with two objectives, the first being based on the predictive loss of the time series model and the second being based on the mutual information between the time series model representation and the LLM model representation. The importance of samples may differ between the two learning objectives. For instance, a substantial traditional prediction loss for a sample indicates significant learning potential for the prediction model, suggesting a need for greater focus on its prediction loss. This scenario implies that the prediction model's learning for a particular sample is less than ideal, suggesting the hidden representation of the time series sample is likely inadequate and should be reduced to de-emphasize the sample in the mutual information calculations. To address this issue, a sample reweighting technique may be used. The reweighting may use a multi layer perceptron (MLP) network that takes the sample prediction loss as input and outputs dual weights for each sample, one for each loss function. These weights can be optimized through bi-level optimization, thereby improving the efficiency of information use.

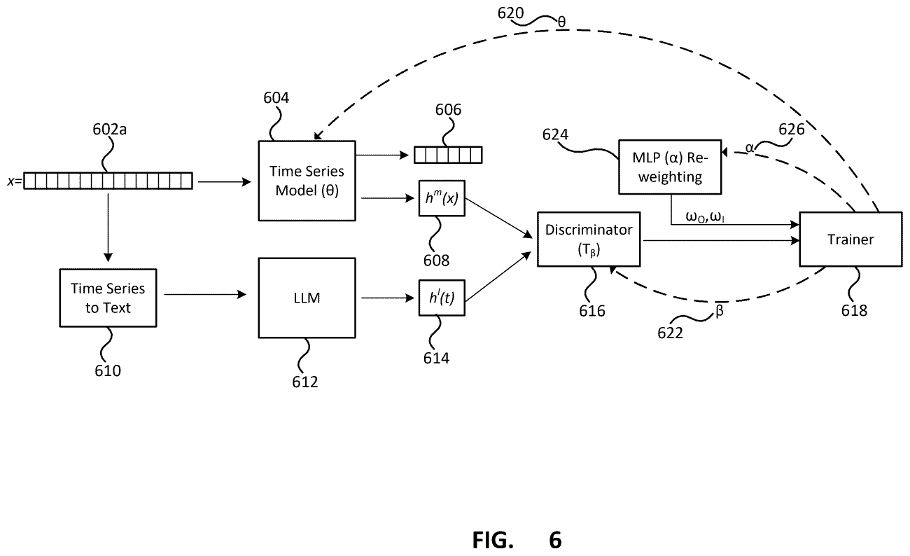

FIG. 6 depicts further training process of a time series model. The process 600 is similar to that described above with reference to FIG. 3, Although the training data time series 302a and labelled results 302b are omitted for simplicity of the figure. Similar to as described above, a training time series x 602a can be provided to a trained, or partially trained, time series model with parameters θ. The model 604 outputs a prediction result 606 as well as provides a hidden representation

$${h}_{θ}^{m} ( x )$$

608. The time series x can be provided to time series to text functionality 610 that converts the time series into a corresponding text representation t. The text representation t can be input into a pre-trained LLM in order to obtain a hidden representation h^{l}(t) 614 of the text from the LLM. A discriminator 616 can be used to estimate the mutual information between the two hidden representations. Training functionality 618 can use the predicted result 606 and the estimated mutual information in order to adjust parameters of the time series model θ 620 and the discriminator parameter β 622.

In order to account for the varying importance of samples to each learning objective, a re-weighting network 626 is employed 622 to provide respective sample weights to each objective loss functions, namely the model prediction loss lₒ and the mutual information maximization loss −I(θ, β). A high prediction loss lₒ indicates a sample's potential learning contribution, warranting a higher weight ωₒ for its prediction loss. This, in turn, implies that the sample's representation might be less than ideal for mutual information calculation, thereby necessitating a reduced weight ω_{I}. In order automate the weight assignment an MLP network parameterized by α can be employed, which outputs a pair of weights for each sample based on the samples prediction loss, as shown in equation (3).

$${ω}_{o} , {ω}_{I} = {MLP}_{α} ( {l}_{O} ) \qquad ( 3 )$$

The sample loss, lₒ, may be transformed into a latent code, z, through an initial hidden layer. Subsequently, the dual weights may be determined according to:

$${ω}_{o} , {ω}_{I} = σ ( {m}_{O} \cdot z ) , σ ( {m}_{I} \cdot z ) \qquad ( 4 )$$

With a learnable mₒ>0 and m_{I}<0 ensuring a negative correlation between ωₒ and ω_{I}.

For a batch of N samples, the importance weights for the mutual information loss ω_{I} are transformed into probabilities

$${p}_{I}^{i} = \frac{{p}_{I}^{i}}{{\sum }_{i = 1}^{N} {p}_{I}^{i}} .$$

This changes the distribution regarding the mutual information computation, recalculating the mutual information equation (1) as I(θ, β, α). The overall loss, [symbol] (θ, α) for a batch of samples can be computed as:

$$ℒ ( θ , α ) = mean ( {ω}_{O} ( α ) ) \cdot {l}_{O} ) + mean ( {ω}_{I} ( α ) ) \cdot [ - I ( θ , β , {ω}_{I} ( α ) ) ] \qquad ( 5 )$$

where:
mean(ωₒ) represents the collective significance of the predictive loss and mean(ω_{I}) represents the collective significance of mutual information maximization for the batch of samples.

Recalling I(θ, β) from equation (1), the calculation presumes a uniform distribution of samples. However, when calculating the dual importance weights, probabilities

$${p}_{I}^{i}$$

for each of the samples introduces a non-uniform distribution. For a batch of N samples, the expected value can be computed as:

$${𝔼}_{𝕤} [ - sp ( - {T}_{β} ( {h}_{θ}^{m} ( x ) , {h}^{l} ( t ) ) ] = - {\sum }_{i = 1}^{N} {p}_{I}^{i} sp ( - {T}_{β} ( {h}_{θ}^{m} ( {x}^{i} ) , {h}^{l} ( {t}^{i} ) ) \qquad ( 6 )$$

$$- {𝔼}_{𝕤 \times \tilde{𝕤}} [ sp ( - {T}_{β} ( {h}_{θ}^{m} ( x ) , {h}^{l} ( \tilde{t} ) ) ] = {\sum }_{i} {\sum }_{i \neq j} {\hat{p}}^{ij} sp ( {T}_{β} ( {h}_{θ}^{m} ( {x}^{i} ) , {h}^{l} ( {\tilde{t}}^{j} ) ) \qquad ( 7 )$$

In the above \hat{p}^{ij} may be defined as:

$$\frac{{p}_{I}^{i} \cdot {p}_{I}^{j}}{{\sum }_{i} {\sum }_{i \neq j} {p}_{I}^{i} \cdot {p}_{I}^{j}} \qquad ( 8 )$$

Since

$${p}_{I}^{i}$$

is produced from the dual weighting network with parameters β, I(θ, β) can be rewritten as I(θ, β, α).

As depicted in FIG. 6, the training functionality 618 may be used to train the MLP re-weighting network 624. The training of the MLP network may be performed once, for example to initially train the network, and/or may be updated as the training data is processed similar to the time series model and the discriminator. The training may optimize the parameters α of the re-weighting network by leveraging the supervision signals from a small validation dataset. If the weighting network is optimized, the model, when trained with these weight, is anticipated to exhibit enhanced performance on the validation dataset in terms of a validation loss:

$${ℒ}_{V} ( θ ) = \frac{1}{M} {\sum }_{j}^{M} {l}_{O}^{j} \qquad ( 9 )$$

This forms a bi-level optimization problem. At the inner level, model training is performed through gradient optimization according to:

$$\hat{θ} ( α ) = θ - {η}_{1} \cdot \frac{\partial ℒ ( θ , α )}{\partial θ} \qquad ( 10 )$$

The aim is for the model trained according to (10) to perform well on the validation set according to:

$$\hat{α} = α - {η}_{2} \cdot \frac{\partial {ℒ}_{V} ( θ , α )}{\partial θ} \qquad ( 11 )$$

Both η₁ and η₂ represent learning rates. Through the minimization of the validation loss, the weighting network parameters a are optimized.

A training algorithm for training the time series model using LLM enhancements with dual weightings, referred to as LLM-Time-DualWeighting, is described below. This algorithm is similar to Algorithm 1 described above, but incorporates the MLP sample re-weighting.

Algorithm 2 LLM-Time-Integrator-DualWeighting

```
Input: The time series dataset [symbol]    , the number of training iterations T
Output: The trained model parameterized by θ*
  1: Train a TimesNet model parameterized by θ on [symbol]    .
  2: Generate the text description t for the time series x
  3: Derive hidden representations h_{θ}^{m}(x) from TimesNet
  4: Derive hidden representation h^{l}(t) from the LLM
  5: Train a discriminator model to T_{β} to estimate mutual information
  6: for τ ← 0 to T − 1 do
```

1: Sample x_{batch}, t_{batch}, y_{batch} from the training data
2: Optimize the discriminator model T_{β}
3: Compute the mutual information loss
4: Process sample loss lₒ with reweighting network to produce dual weights
5: Adopt bi-level optimization to update reweighting network
6: Assign dual weights to samples using reweighting network
7: Compute the overall loss with dual weighted samples
8: Update model parameters based on overall loss

```
  7: next
  8: Return the trained model parameterized by θ*
```

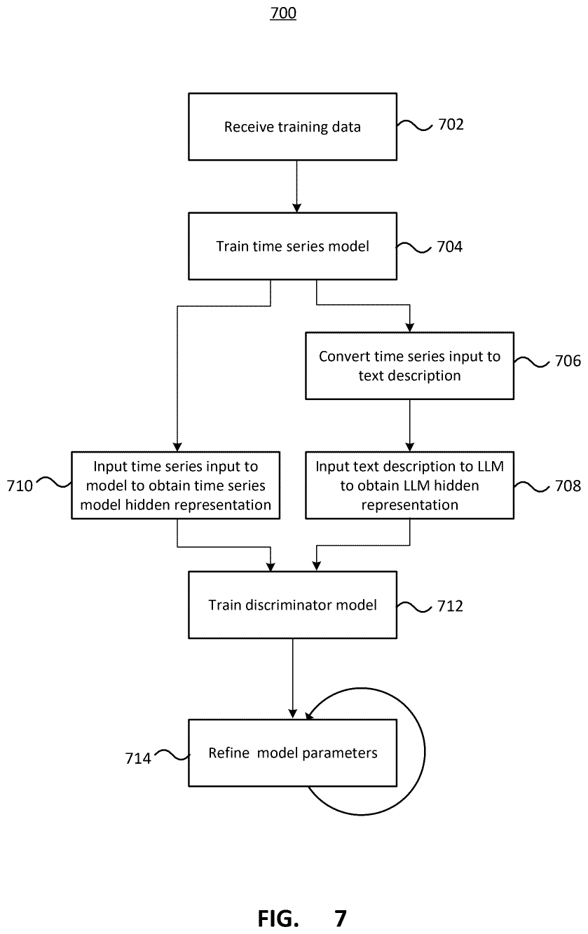

FIG. 7 depicts a further method of training a time series model. The method 700 receives training data (702) that includes time series data and labelled results or ground truth data. The training data is used to train the time series model (704). In order to train a discriminator model, the time series data is converted to a corresponding text description (706) which is used as input to a pre-trained LLM in order to obtain an LLM hidden representation of the text (708). The time series is provided to the initially trained time series model to obtain a time series model hidden representation (710). The two hidden representations can then be used to train a discriminator model (712) that estimates the mutual information between the two hidden representations. Once the time series model and the discriminator are initial trained, the parameters of one, or both, models can be continually refined from the training data (714). The training may perform a number of iterations, with each iteration refining the model parameters based on one or more samples from the training data.

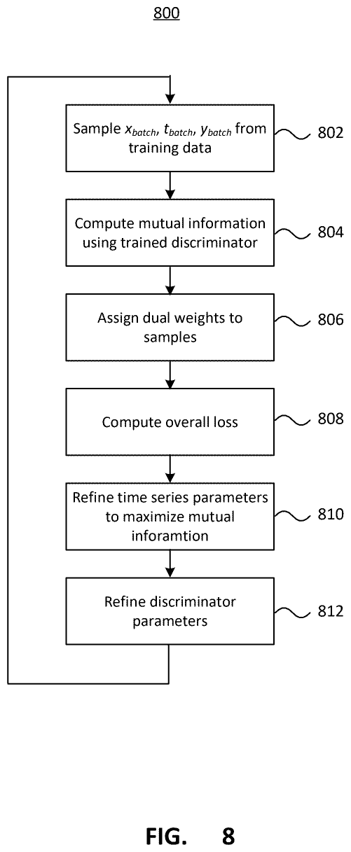

FIG. 8 depicts details of refining model parameters. The method 800 may be used to continually refine the model parameters as described above with reference to FIG. 7. The method can sample a batch of samples from the training data (802), the batch including time series samples x_{batch}, corresponding text samples t_{hatch}, and labelled results samples y_{batch}. If the batches of corresponding text samples are not available, they may be automatically generated from the time series samples. The mutual information between corresponding samples, or rather the hidden time series representation and LLM representations of the corresponding samples is determined (804). If the process uses dual weightings, the dual weights for the samples of the batch can be determined and assigned to the samples (806). The overall loss is computed (808), which may include both the predictive loss and the mutual information loss, possibly re-weighted according to the mutual information loss. The time series model parameters can be determined from the computed overall loss in order to maximize mutual information (810). The mutual information may also be used to refine the discriminator parameters (812).

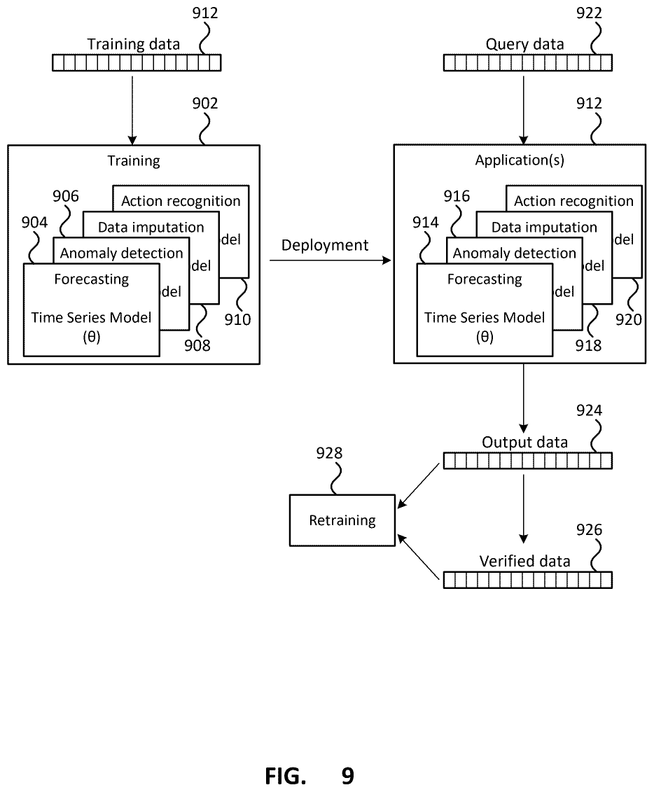

FIG. 9 depicts the training and application of different time series models. The above has described training a time series model using LLM enhancements. The time series model can be trained on a wide range of applications. As depicted, the training 902 as described above may be applied to different time series models for different applications such as forecasting, 904, anomaly detection 906, data imputation 908 and action recognition 910. Each of the predictive models may be trained on training data 912 according to the training process described above. The predictive loss may vary depending upon the different time series model. Once trained on the training data 912, the trained time series model may be deployed and used in various applications 912. The various trained time series models may be used for various purposes such as forecasting, 914, anomaly detection 916, data imputation 918 and action recognition 920. In each application, query or input data 922, comprising time series data is input to the trained model, or models, 914, 916, 918, 920. The models generate output data 924, which is depicted as time series data, however the model output does not need to be time series data and may comprise other data such as a detected anomaly, activity, missing output etc. It is possible that the output data 924 can be subsequently verified 926. The verified data may be provided by explicit user input or feedback, or may be collected automatically. For example, in the case of forecasting future values of the data, when the future time occurs, the resulting data may be the verified data 926. The output data 924 and the verified data 926 may be used to retrain the time series model in order to improve the predictions. The retraining may identify samples that are particularly useful for retraining such as output data 924 that differs significantly from the verified data 926.

The training process described above can effectively integrate the benefits of LLMs into a traditional time series model. Once the trained model is deployed, it's use is substantially the same as a traditional TS model, although as highlighted further below, the LLM enhanced model can perform better on a wide range of tasks. The LLM-enhanced TS model training is able to apply the benefits of LLM models that are trained on a large collection of texts without having to re-train or fine tune the LLM model for use with time series data.

The above has described the enhanced training of time series models using an LLM.

To affirm the comprehensive applicability of the LLM-Time-Integrator trained according to the processes described above, extensive experiments across five main tasks were performed. The main tasks included short-term forecasting, long-term forecasting, data imputation, classification, and anomaly detection. To maintain experimental integrity, the methodology adheres to the setup outlined by TimesNet in Wu et al.

Baselines. The current evaluation encompasses a wide array of baseline models, spanning various architectural approaches to ensure a thorough comparative analysis: (1) CNN-based models, exemplified by TimesNet; (2) MLP-based models, including LightTS and DLinear; (3) Transformer-based models, featuring Reformer, Informer, Autoformer, FEDformer, Nonstation-ary Transformer, ETSformer, and PatchTST; (4) LLM-based models, notably FPT. Additionally, for forecasting tasks, LLM-Time and Time-LLM were evaluated.

Specifically for short-term forecasting, models such as N-HITS and N-BEATS were included; Anomaly detection was further scrutinized using Anomaly Transformer; For classification endeavors, models like XGBoost, Rocket, LSTNet, LSSL, Pyraformer, TCN, and Flowformer were considered. This encompassing selection of baselines facilitates a robust and equitable comparison across the diverse tasks, illuminating the strengths of the LLM-Time-Integrator approach described herein.

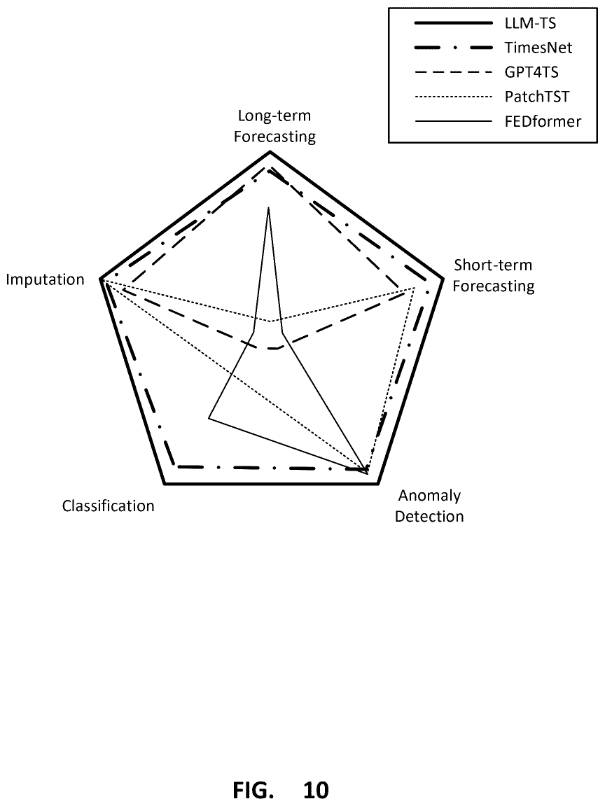

FIG. 10 depicts a radar graph of results of different models on different tasks. The tasks include: 1) Long-term forecasting, 2) Short-term forecasting, 3) Anomaly detection, 4) Classification, and 5) Imputation. The TS models include the LLM-enhanced TS model (LLM-TS) described herein, the standard TimesNet model, GPT4TS, PatchTST, and FEDformer. AS can be seen from FIG. 10, the currently described LLM-TS Integrator model consistently outperforms other methods in various tasks, underscoring its efficacy.

The results of the classification tasks are described in Tables 1A and 1B below. The results of the anomaly detection tasks are described below in Tables 2A and 2B below. The results of short-term M4 forecasting are described below in Tables 3a and 3B below. The results of long-term forecasting are described below in Tables 4a and 4B below. The results of imputation are described in tables 5a and 5b below. F1-score (as %) are calculated per dataset. “*” in the Transformers indicates the name of “*former”.

### Classification Task

Time series classification has significant applications in fields such as recognition technologies and medical diagnostics. Application of the current model was focused on sequence-level time series classification tasks, a crucial test of its ability to learn high-level representations from data. Specifically, 10 diverse multivariate datasets were employed that were sourced from the UEA Time Series Classification repository. These datasets encompass a wide range of real-world applications, including gesture and action recognition, audio processing, medical diagnosis, among other practical domains. The current training approach performs well across tasks.

TABLE 1A
Classification task

| | Classical Methods | | RNN | | | Transformers | | | |
|---|---|---|---|---|---|---|---|---|---|
| Methods | XGBoost | Rockler | LSTNet | LSSL | TCN | Trans. | Re. | In. | Pyra. |
| EthanolConcentration | 43.7 | 45.2 | 39.9 | 31.1 | 28.9 | 32.7 | 31.9 | 31.6 | 30.8 |
| FaceDetection | 63.3 | 64.7 | 65.7 | 66.7 | 52.8 | 67.3 | 68.6 | 67.0 | 65.7 |
| Handwriting | 15.8 | 58.8 | 25.8 | 24.6 | 53.3 | 32.0 | 27.4 | 32.8 | 29.4 |
| Heartbeat | 73.2 | 75.6 | 77.1 | 72.7 | 75.6 | 76.1 | 77.1 | 80.5 | 75.6 |
| JapaneseVowels | 86.5 | 96.2 | 98.1 | 98.4 | 98.9 | 98.7 | 97.8 | 98.9 | 98.4 |
| PEMS-SF | 98.3 | 75.1 | 86.7 | 86.1 | 68.8 | 82.1 | 82.7 | 81.5 | 83.2 |
| SelfRegulationSCP1 | 84.6 | 90.8 | 84.0 | 90.8 | 84.6 | 92.2 | 90.4 | 90.1 | 88.1 |
| SelfRegulationSCP2 | 48.9 | 53.3 | 52.8 | 52.2 | 55.6 | 53.9 | 56.7 | 53.3 | 53.3 |
| SpokenArabicDigits | 69.6 | 71.2 | 100.0 | 100.0 | 95.6 | 98.4 | 97.0 | 100.0 | 99.6 |
| UWaveGestureLibrary | 75.9 | 94.4 | 87.8 | 85.9 | 88.4 | 85.6 | 85.6 | 85.6 | 83.4 |
| Average | 66.0 | 72.5 | 71.8 | 70.9 | 70.3 | 71.9 | 71.5 | 72.1 | 70.8 |

TABLE 1B
Classification task

| | Transformers | | | | | | | Times | |
|---|---|---|---|---|---|---|---|---|---|
| Methods | Auto. | Station. | FED. | ETS. | Flow. | DLinear | LightTS | Net | Current |
| EthanolConcentration | 31.6 | 32.7 | 31.2 | 28.1 | 33.8 | 32.6 | 29.7 | 30.4 | 31.9 |
| FaceDetection | 68.4 | 68.0 | 66.0 | 66.3 | 67.6 | 68.0 | 67.5 | 68.6 | 68.9 |
| Handwriting | 36.7 | 31.6 | 28.0 | 32.5 | 33.8 | 27.0 | 26.1 | 32.1 | 35.3 |
| Heartbeat | 74.6 | 73.7 | 73.7 | 71.2 | 77.6 | 75.1 | 75.1 | 78.0 | 77.6 |
| JapaneseVowels | 96.2 | 99.2 | 98.4 | 95.9 | 98.9 | 96.2 | 96.2 | 98.4 | 98.4 |
| PEMS-SF | 82.7 | 87.3 | 80.9 | 86.0 | 83.8 | 75.1 | 88.4 | 89.6 | 90.8 |
| SelfRegulationSCP1 | 84.0 | 89.4 | 88.7 | 89.6 | 92.5 | 87.3 | 89.8 | 88.9 | 91.8 |
| SelfRegulationSCP2 | 50.6 | 57.2 | 54.4 | 55.0 | 56.1 | 50.5 | 51.1 | 57.1 | 57.8 |
| SpokenArabicDigits | 100.0 | 100.0 | 100.0 | 100.0 | 98.8 | 81.4 | 100.0 | 99.0 | 98.6 |
| UWaveGestureLibrary | 85.9 | 87.5 | 85.3 | 85.0 | 86.6 | 82.1 | 80.3 | 85.3 | 86.6 |
| Average | 71.1 | 72.7 | 70.7 | 71.0 | 73.0 | 67.5 | 70.4 | 72.7 | 73.8 |

### Anomaly Detection Task

The identification of anomalies within monitoring data plays a crucial role in ensuring industrial maintenance and reliability. The current study concentrates on unsupervised time series anomaly detection, aiming to identify aberrant time points indicative of potential issues. The current model was benchmarked against five established anomaly detection datasets: SMD, MSL, SMAP, SWaT, and PSM. These datasets span a variety of applications, including service monitoring, space and earth exploration, and water treatment processes. For a consistent evaluation framework across all experiments, we employ the classical reconstruction error metric to determine anomalies. As can be seen, the current training approach performs well across tasks.

TABLE 2A
Anomaly detection task

| Methods | Current | TimesNet | PatchTS. | ETS. | FED. | LightTS | DLinear | Stationary |
|---|---|---|---|---|---|---|---|---|
| SMD | 84.69 | 84.57 | 84.62 | 83.13 | 85.08 | 82.53 | 77.10 | 84.72 |
| MSL | 81.11 | 80.34 | 78.70 | 85.03 | 78.57 | 78.95 | 84.88 | 77.50 |
| SMAP | 69.41 | 69.39 | 68.82 | 69.50 | 70.76 | 69.21 | 69.26 | 71.09 |
| SWaT | 93.12 | 93.02 | 85.72 | 84.91 | 93.19 | 93.33 | 87.52 | 79.88 |
| PSM | 97.43 | 97.27 | 96.08 | 91.76 | 97.23 | 97.15 | 93.55 | 97.29 |
| Average | 85.15 | 84.92 | 82.79 | 82.87 | 84.97 | 84.23 | 82.46 | 82.08 |

TABLE 2B
Anomaly detection task

| Methods | Auto. | Pyra. | Anomaly.** | In. | Re. | Trans. |
|---|---|---|---|---|---|---|
| SMD | 85.11 | 83.04 | 85.49 | 81.65 | 75.32 | 79.56 |
| MSL | 79.05 | 84.86 | 83.31 | 84.06 | 84.40 | 78.68 |
| SMAP | 71.12 | 71.09 | 71.18 | 69.92 | 70.40 | 69.70 |
| SWaT | 92.74 | 91.78 | 83.10 | 81.43 | 82.80 | 80.37 |
| PSM | 93.29 | 82.08 | 79.40 | 77.10 | 73.61 | 76.07 |
| Average | 84.26 | 82.57 | 80.50 | 78.83 | 77.31 | 76.88 |

### Short-Term and Long-Term Forecasting Task

To comprehensively assess the LLM-TS model's forecasting capabilities, the model was engaged in both short-and long-term forecasting settings. In the realm of short-term forecasting, the M4 dataset was used, which aggregates univariate marketing data on a yearly, quarterly, and monthly basis. For long-term forecasting, five datasets were examined including ETT, Electricity, Traffic, Weather, and ILI. The TimesNet settings were adhered to with an input length of 96. For LLM-based methods like GPT4TS and Time-LLM, which use different input lengths, the experiments were run using their code. For PatchTST, the results from Wang et al., 2023a, as the original PatchTST uses an input length of 512. Due to shorter input lengths in this study compared to the original, the reported performance is lower. For short-term forecasting, the prediction lengths are in [6, 48] and results are obtained by weighting averages across multiple datasets with varying sampling intervals. For long-term forecasting, Averages over 4 lengths: 24, 36, 48, 60 for ILI, and 96, 192, 336, 720 for others

TABLE 3a
Short-term forecasting task

| Methods | LLM-TS | TimesNet | GPT4TS | TIME-LLM | TEST | PatchTST | N-HiTS |
|---|---|---|---|---|---|---|---|
| SMAPE | 11.819 | 11.908 | 11.991 | 11.983 | 11.927 | 12.059 | 11.927 |
| MASE | 1.588 | 1.612 | 1.600 | 1.595 | 1.613 | 1.623 | 1.613 |
| OWA | 0.851 | 0.860 | 0.861 | 0.859 | 0.861 | 0.869 | 0.861 |

TABLE 3b
Short-term forecasting task

| Methods | N-BEATS | FED. | Stationary | Auto. |
|---|---|---|---|---|
| SMAPE | 11.851 | 12.840 | 12.780 | 12.909 |
| MASE | 1.599 | 1.701 | 1.756 | 1.771 |
| OWA | 0.855 | 0.918 | 0.930 | 0.939 |

TABLE 4a
Long-term forecasting task

| | LLM-TS | | TimesNet | | TIME-LLM | | DLinear | | PatchTST | |
|---|---|---|---|---|---|---|---|---|---|---|
| Methods | MSE | MAE | MSE | MAE | MSE | MAE | MSE | MAE | MSE | MAE |
| Weather | 0.257 | 0.285 | 0.265 | 0.290 | 0.279 | 0.292 | 0.265 | 0.317 | 0.265 | 0.285 |
| ETTh1 | 0.454 | 0.451 | 0.470 | 0.462 | 0.474 | 0.459 | 0.456 | 0.452 | 0.516 | 0.484 |
| ETTh2 | 0.396 | 0.413 | 0.413 | 0.426 | 0.398 | 0.415 | 0.559 | 0.515 | 0.391 | 0.411 |
| ETTm1 | 0.401 | 0.409 | 0.414 | 0.418 | 0.437 | 0.412 | 0.403 | 0.407 | 0.406 | 0.407 |
| ETTm2 | 0.295 | 0.33 | 0.294 | 0.331 | 0.298 | 0.342 | 0.350 | 0.401 | 0.290 | 0.334 |
| ILI | 1.973 | 0.894 | 2.266 | 0.974 | 2.726 | 1.098 | 2.616 | 1.090 | 2.184 | 0.906 |
| ECL | 0.194 | 0.299 | 0.198 | 0.298 | 0.229 | 0.315 | 0.212 | 0.300 | 0.216 | 0.318 |
| Traffic | 0.618 | 0.333 | 0.627 | 0.335 | 0.606 | 0.395 | 0.625 | 0.383 | 0.529 | 0.341 |
| Average | 0.574 | 0.427 | 0.918 | 0.442 | 0.681 | 0.468 | 0.686 | 0.483 | 0.600 | 0.436 |

TABLE 4b
Long-term forecasting task

| | GPT4TS | | FEDformer | | TEST | | Stationary | | ETSFormer | |
|---|---|---|---|---|---|---|---|---|---|---|
| Methods | MSE | MAE | MSE | MAE | MSE | MAE | MSE | MAE | MSE | MAE |
| Weather | 0.275 | 0.292 | 0.309 | 0.360 | 0.291 | 0.315 | 0.288 | 0.314 | 0.271 | 0.334 |
| ETTh1 | 0.473 | 0.451 | 0.440 | 0.460 | 0.440 | 0.460 | 0.570 | 0.537 | 0.542 | 0.510 |
| ETTh2 | 0.383 | 0.410 | 0.437 | 0.449 | 0.414 | 0.432 | 0.526 | 0.516 | 0.439 | 0.452 |
| ETTm1 | 0.408 | 0.400 | 0.448 | 0.452 | 0.402 | 0.411 | 0.481 | 0.456 | 0.429 | 0.425 |
| ETTm2 | 0.290 | 0.335 | 0.305 | 0.349 | 0.323 | 0.359 | 0.306 | 0.347 | 0.293 | 0.342 |
| ILI | 5.117 | 1.650 | 2.847 | 1.144 | 3.324 | 1.232 | 2.077 | 0.914 | 2.497 | 1.004 |
| ECL | 0.206 | 0.285 | 0.214 | 0.327 | 0.237 | 0.324 | 0.193 | 0.296 | 0.208 | 0.323 |
| Traffic | 0.561 | 0.373 | 0.610 | 0.376 | 0.571 | 0.388 | 0.624 | 0.340 | 0.621 | 0.396 |
| Average | 0.964 | 0.525 | 0.701 | 0.489 | 0.756 | 0.49 | 0.633 | 0.465 | 0.662 | 0.473 |

### Imputation Task

To assess the LLM-TS model's imputation capabilities, three datasets were employed: ETT, Electricity, and Weather, serving as the benchmarks. To simulate various degrees of missing data, time points were randomly obscured at proportions of {12.5%, 25%, 37.5%, 50%}.

TABLE 4a
Long-term forecasting task

| | LLM-TS | | TimesNet | | GPT4TS | | PatchTST | | LightTS | |
|---|---|---|---|---|---|---|---|---|---|---|
| Methods | MSE | MAE | MSE | MAE | MSE | MAE | MSE | MAE | MSE | MAE |
| ETTm1 | 0.025 | 0.103 | 0.028 | 0.109 | 0.028 | 0.108 | 0.047 | 0.140 | 0.104 | 0.218 |
| ETTm2 | 0.021 | 0.087 | 0.022 | 0.089 | 0.023 | 0.088 | 0.029 | 0.102 | 0.046 | 0.151 |
| ETTh1 | 0.087 | 0.198 | 0.090 | 0.199 | 0.069 | 0.174 | 0.115 | 0.224 | 0.284 | 0.373 |
| ETTh2 | 0.050 | 0.148 | 0.051 | 0.150 | 0.050 | .0144 | 0.065 | 0.163 | 0.119 | 0.250 |
| ECL | 0.94 | 0.211 | 0.095 | 0.212 | 0.091 | 0.207 | 0.072 | 0.183 | 0.131 | 0.262 |
| Weather | 0.030 | 0.056 | 0.031 | 0.059 | 0.032 | 0.058 | 0.034 | 0.055 | 0.055 | 0.117 |
| Average | 0.051 | 0.134 | 0.053 | 0.136 | 0.049 | 0.130 | 0.060 | 0.144 | 0.123 | 0.228 |

TABLE 4b
Long-term forecasting task

| | DLinear | | FEDformer | | Stationary | | Autoformer | | Reformer | |
|---|---|---|---|---|---|---|---|---|---|---|
| Methods | MSE | MAE | MSE | MAE | MSE | MAE | MSE | MAE | MSE | MAE |
| ETTm1 | 0.093 | 0.206 | 0.062 | 0.177 | 0.036 | 0.126 | 0.051 | 0.150 | 0.055 | 0.166 |
| ETTm2 | 0.096 | 0.208 | 0.101 | 0.215 | 0.026 | 0.099 | 0.029 | 0.105 | 0.157 | 0.280 |
| ETTh1 | 0.201 | 0.306 | 0.117 | 0.246 | 0.094 | 0.201 | 0.103 | 0.214 | 0.122 | 0.245 |
| ETTh2 | 0.142 | 0.259 | 0.163 | 0.279 | 0.053 | 0.152 | 0.055 | 0.156 | 0.234 | 0.352 |
| ECL | 0.132 | 0.260 | 0.130 | 0.259 | 0.100 | 0.218 | 0.101 | 0.225 | 0.200 | 0.313 |
| Weather | 0.052 | 0.110 | 0.099 | 0.203 | 0.032 | 0.059 | 0.031 | 0.057 | 0.038 | 0.087 |
| Average | 0.119 | 0.224 | 0.112 | 0.229 | 0.056 | 0.142 | 0.061 | 0.151 | 0.134 | 0.240 |

It will be appreciated by one of ordinary skill in the art that the system and components shown in FIGS. 1-10 can include components not shown in the drawings. For simplicity and clarity of the illustration, elements in the figures are not necessarily to scale, are only schematic and are non-limiting of the elements structures. It will be apparent to persons skilled in the art that a number of variations and modifications can be made without departing from the scope of the invention as defined in the claims.

Although certain components and steps have been described, it is contemplated that individually described components, as well as steps, can be combined together into fewer components or steps or the steps can be performed sequentially, non-sequentially or concurrently. Further, although described above as occurring in a particular order, one of ordinary skill in the art having regard to the current teachings will appreciate that the particular order of certain steps relative to other steps can be changed. Similarly, individual components or steps can be provided by a plurality of components or steps. One of ordinary skill in the art having regard to the current teachings will appreciate that the components and processes described herein can be provided by various combinations of software, firmware and/or hardware, other than the specific implementations described herein as illustrative examples.

While certain features, components, functionality, steps etc. may be described with respect to a particular embodiment, the certain features, components, functionality, steps, etc. may be incorporated into other described embodiments.

The techniques of various embodiments can be implemented using software, hardware and/or a combination of software and hardware. Various embodiments are directed to apparatus, e.g. a node which can be used in a communications system or data storage system. Various embodiments are also directed to non-transitory machine, e.g., computer, readable medium, e.g., ROM, RAM, CDs, hard discs, etc., which include machine readable instructions for controlling a machine, e.g., processor to implement one, more or all of the steps of the described method or methods.

Some embodiments are directed to a computer program product comprising a computer-readable medium comprising code for causing a computer, or multiple computers, to implement various functions, steps, acts and/or operations, e.g. one or more or all of the steps described above. Depending on the embodiment, the computer program product can, and sometimes does, include different code for each step to be performed. Thus, the computer program product may, and sometimes does, include code for each individual step of a method, e.g., a method of operating a communications device, e.g., a wireless terminal or node. The code can be in the form of machine, e.g., computer, executable instructions stored on a computer-readable medium such as a RAM (Random Access Memory), ROM (Read Only Memory) or other type of storage device. In addition to being directed to a computer program product, some embodiments are directed to a processor configured to implement one or more of the various functions, steps, acts and/or operations of one or more methods described above. Accordingly, some embodiments are directed to a processor, e.g., CPU, configured to implement some or all of the steps of the method(s) described herein. The processor can be for use in, e.g., a communications device or other device described in the present application.

Numerous additional variations on the methods and apparatus of the various embodiments described above will be apparent to those skilled in the art in view of the above description. Such variations are to be considered within the scope.

What is claimed is:

1. A method of training a time series model comprising:
receiving training data comprising a time-series and associated ground truth results;
inputting a portion of the training data, x, to a time series model to provide a time series hidden representation,
$${h}_{θ}^{m} ( x ) ,$$
of the input portion of the training data from the time series model, the time series model being trained to predict the ground truth results;
inputting text description, t, corresponding to the training data x to a large language model (LLM) to provide an LLM hidden representation, h^{l}(t), of the input text description corresponding to the portion of the training data from the LLM, the LLM trained to output a text response from an input;
determining mutual information between
$${h}_{θ}^{m} ( x )$$
and h^{l}(t) using a discriminator model T_{β}; and
adjusting parameters, θ, of the time series model based at least in part on the determined mutual information between
$${h}_{θ}^{m} ( x )$$
and h^{l}(t).

2. The method of claim 1, wherein adjusting parameters, θ, is calculated based on an overall loss function comprising:
a predictive loss based on the training data x and a corresponding ground truth label y; and
a mutual information maximization loss based on the mutual information between
$${h}_{θ}^{m} ( x )$$
and h^{l}(t).

3. The method of claim 2, wherein the overall loss function [symbol] (θ) is defined by:
$$ℒ ( θ , β ) = \frac{1}{N} {\sum }_{i}^{N} {l}_{O}^{i} + I ( θ , β )$$
where:
N is a number of samples in the training data x;
l₀^{l} is the predictive loss for sample i;
I(θ, β) is the mutual information maximization loss;
θ is the parameters of the time series model; and
β is the parameters of the discriminator model.

4. The method of claim 1, wherein the overall loss function assigns different sample weightings to the predictive loss function and the loss function maximizing the mutual information.

5. The method of claim 4, wherein the overall loss function [symbol] (θ, β) is defined by:
$$ℒ ( θ , α ) = mean ( {ω}_{O} ( α ) \cdot {l}_{O} ) + mean ( {ω}_{I} ( α ) \cdot [ - I ( θ , β , {ω}_{I} ( α ) ]$$
where:
lₒ is a predictive loss function;
−I(θ, β, ωₗ(α) is a mutual information maximization loss function;
ωₒ(α) is a predictive loss weighting; and
ω_{I}(α) is a mutual information maximization loss weighting;
α is the parameters of a weighting network MLP_{α}; and
ωₒ(α), ω_{I}(α)=MLP_{α}(lₒ).

6. The method of claim 5, wherein the weighting network is trained as a bi-level optimization problem.

7. The method of claim 1, further comprising:
training the discriminator model T_{β}using the received training data.

8. The method of claim 7, wherein parameters β of T_{β}are optimized according to:
$$\hat{β} = β - {η}_{0} \cdot \frac{\partial I ( θ , β )}{\partial β} ,$$
$$with :$$
$$I ( θ , β ) = {𝔼}_{𝕤} [ - sp ( - {T}_{β} ( {h}_{θ}^{m} ( x ) , {h}^{l} ( t ) ) ] - {𝔼}_{𝕤 \times \tilde{𝕤}} [ sp ( - {T}_{β} ( {h}_{θ}^{m} ( x ) , {h}^{l} ( \tilde{t} ) ) ] ,$$
where:
ηₒ is a learning rate; [symbol]
[] is an expected value; and
sp is a softplus function.

9. The method of claim 1, further comprising converting the input portion of training data to a text description, t, corresponding to the input portion of training data.

10. The method of claim 1, wherein the method is repeated for a plurality of training epochs before deploying the time series model with the adjusted parameters.

11. The method of claim 1, further comprising:
generating the text description t based on a template.

12. A system comprising:
a processor for executing instructions; and
a non-transitory computer readable medium having instructions stored thereon, which when executed by the processor configure the system to perform a method according to claim 1.

13. The system of claim 12, wherein adjusting parameters, θ, is calculated based on an overall loss function comprising:
a predictive loss based on the training data x and a corresponding ground truth label y; and
a mutual information maximization loss based on the mutual information between
$${h}_{θ}^{m} ( x )$$
and h^{l}(t).

14. The system of claim 13, wherein the overall loss function [symbol] (θ) is defined by:
$$ℒ ( θ , β ) = \frac{1}{N} {\sum }_{i}^{N} {l}_{O}^{i} + l ( θ , β )$$
where:
N is a number of samples in the training data x;
lₒ^{l} is the predictive loss for sample i;
I(θ, β) is the mutual information maximization loss;
θ is the parameters of the time series model; and
β is the parameters of the discriminator model.

15. The system of claim 12, wherein the overall loss function assigns different sample weightings to the predictive loss function and the loss function maximizing the mutual information.

16. The system of claim 15, wherein the overall loss function [symbol] (θ, β) is defined by:
$$ℒ ( θ , α ) = mean ( {ω}_{O} ( α ) \cdot {l}_{O} ) + mean ( {ω}_{I} ( α ) \cdot [ - I ( θ , β , {ω}_{I} ( α ) ]$$
where:
lₒ is a predictive loss function;
−I(θ, α, ω_{I}(α) is a mutual information maximization loss function;
ωₒ (α) is a predictive loss weighting; and
ω_{I}(α) is a mutual information maximization loss weighting;
α is the parameters of a weighting network MLP_{α}; and
ωₒ(α), ω_{I}(α)=MLP_{α}(lₒ).

17. The system of claim 16, wherein the weighting network is trained as a bi-level optimization problem.

18. The system of claim 12, further comprising:
training the discriminator model T_{β}using the received training data.

19. The system of claim 18, wherein parameters β of T_{β}are optimized according to:
$$\hat{β} = β - {η}_{0} \cdot \frac{\partial I ( θ , β )}{\partial β} ,$$
$$with :$$
$$I ( θ , β ) = {𝔼}_{𝕤} [ - sp ( - {T}_{β} ( {h}_{θ}^{m} ( x ) , {h}^{l} ( t ) ) ] - {𝔼}_{𝕤 \times \tilde{𝕤}} [ sp ( - {T}_{β} ( {h}_{θ}^{m} ( x ) , {h}^{l} ( \tilde{t} ) ) ] ,$$
where:
ηₒ is a learning rate; [symbol]
[] is an expected value; and
sp is a softplus function.

20. A non-transitory computer readable medium having instructions stored thereon, which when executed by a processor configure a system to perform a method according to claim 1.
